(19) United States
(12) Patent Application Publication
(10) Pub. No.: US 2009/0232536 A1
(43) Pub. Date: Sep. 17, 2009

(54) Image Forming Apparatus and Image Forming Method

(75) Inventors: Yoshiteru NISHIMURA, Shiojiri-shi (JP); Koichi KAMIJO, Matsumoto-shi (JP); Ken IKUMA, Suwa-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/400,534

(22) Filed: Mar. 9, 2009

(30) Foreign Application Priority Data
Mar. 13, 2008 (JP) 2008-064087
Sep. 18, 2008 (JP) 2008-239657

(51) Int. Cl. G03G 21/00

(52) U.S. Cl. 399/71; 399/101

(57) ABSTRACT

An image forming apparatus includes: a latent image carrier on which an electrostatic latent image is formed; a developing section which develops the electrostatic latent image using a liquid developer, forming an image on the latent image carrier; a transfer medium to which the image on the latent image carrier is transferred; a first transfer member which transfers the image on the latent image carrier to the transfer medium; a second transfer member which transfers the image on the transfer medium to a recording material; a latent image carrier cleaning roller which, as well as making contact with the latent image carrier, forming a nip having a first nip width in a moving direction of the latent image carrier, has a latent image carrier cleaning bias applied thereto, cleaning the latent image carrier, the image of the latent image carrier on which has been transferred to the transfer medium; and a transfer medium cleaning roller which, as well as having a transfer medium cleaning bias applied thereto, cleaning the transfer medium, the image of the transfer medium on which has been transferred to the recording material, makes contact with the transfer medium, forming a second nip width, which is larger than the first nip width, in a moving direction of the transfer medium.

### BACKGROUND

1. Technical Field

The present invention relates to a technical field of an electrophotographic image forming apparatus, such as a copying machine, a facsimile apparatus, or a printer, and a technical field of an image forming method, which carry out an image formation by means of a liquid developer, using an intermediate transfer medium.

2. Related Art

To date, an electrophotographic image forming apparatus has been known which carries out an image formation by means of dry toner, using an intermediate transfer belt (for example, JP-A-2006-317986). In JP-A-2006-317986, the title of the invention is “a wet type image forming apparatus”, but no wet toner is used in this image forming apparatus. In the image forming apparatus described in JP-A-2006-317986, toner remaining on an intermediate transfer belt after a secondary transfer is removed by a bias cleaning method whereby a bias is applied to a cleaning roller.

Meanwhile, in an image forming apparatus which carries out an image formation by means of a liquid developer, using an intermediate transfer medium, it is difficult to remove solid toner contained in the liquid developer, which remains on an intermediate transfer belt after a secondary transfer, by means of the bias cleaning method described in JP-A-2006-317986. The reason is as follows. In the case of using a liquid developer, steps for an image formation, such as a developing step, a primary transfer step, an intermediate transfer belt squeeze step unique to the liquid developer, and a secondary transfer step, are sequentially carried out at an image formation time. As the steps are carried out in this way, an amount of carrier oil in the liquid developer decreases gradually. For this reason, as shown in Table 1, a ratio of solid toner in the liquid developer increases, and a ratio of solid toner from the liquid developer on the intermediate transfer belt after the secondary transfer becomes higher than a ratio of solid toner from the liquid developer on a photoreceptor after the primary transfer.

TABLE 1

| | | Solid amount | Carrier amount |
|---|---|---|---|
| | Solid ratio (%) | (mg/cm²) | (mg/cm²) |
| Photoreceptor | 25.6 | 0.11 | 0.32 |
| Intermediate transfer belt | 40.7 | 0.11 | 0.16 |
| (monochrome) | | | |
| Intermediate transfer belt | 42.0 | 0.29 | 0.40 |
| (three colors) | | | |

Solid ratio (%) = {(solid amount)/(solid amount + liquid carrier amount)} · 100

However, as a charge amount of solid toner decreases when the ratio of solid toner increases, a charge amount of solid toner on the intermediate transfer belt becomes smaller than a charge amount of solid toner on the photoreceptor. Furthermore, by passing through a nip in each heretofore described step, the solid toner, after the secondary transfer, adheres to the intermediate transfer belt with an adhesion greater than an adhesion to the photoreceptor.

Therein, in order to remove the solid toner on the intermediate transfer belt after the secondary transfer by means of the heretofore described bias cleaning method described in JP-A-2006-317986, it is necessary to increase a bias applied to the cleaning roller.

However, on an excess bias simply being applied to the cleaning roller in the way heretofore described, the intermediate transfer belt being charged due to a charge injection, there is a problem in that it is impossible to effectively carry out an image formation after a cleaning of the intermediate transfer belt.

### SUMMARY

An advantage of some aspects of the invention is to provide an image forming apparatus, and an image forming method, which, even using a liquid developer, can effectively carry out an image formation after a cleaning of an intermediate transfer medium while more effectively carrying out a removal of solid toner remaining on the intermediate transfer medium after a transfer.

In an image forming apparatus and image forming method according to some aspects of the invention, by bringing a latent image carrier cleaning roller into contact with a latent image carrier, and applying a latent image carrier cleaning bias to the latent image carrier cleaning roller, a liquid developer remaining on the latent image carrier after a transfer is removed. Also, by bringing a transfer medium cleaning roller into contact with a transfer medium at a second nip width, which is larger than a first nip width at which the latent image carrier cleaning roller is nipped on the latent image carrier, and applying a transfer medium cleaning bias to the transfer medium cleaning roller, a liquid developer remaining on the transfer medium from which an image has been transferred to a recording material is removed.

Consequently, even in the event that solid toner from the liquid developer adheres to the transfer medium with an adhesion greater than an adhesion to the latent image carrier, as in the heretofore known apparatus heretofore described, it is possible to efficiently remove solid toner adhering to the latent image carrier after the transfer, and solid toner adhering to the transfer medium after the transfer, by means of biases applied to the latent image carrier cleaning roller and the transfer medium cleaning roller, respectively.

In particular, by means of the fact that the second nip width of the transfer medium cleaning roller is larger than the first nip width of the latent image carrier cleaning roller, it is possible to set a solid toner nip transit time (a solid toner electrophoresis time) in the transfer medium, which has a high solid toner adhesion and is hard to clean, so as to be longer than a solid toner nip transit time in the latent image carrier. Consequently, it is possible to effectively remove solid toner on the transfer medium which is hard to remove. Also, by this means, as it is possible to make the bias applied to the transfer medium cleaning roller comparatively low, it is possible to suppress an effect on the transfer medium due to the bias. As a result, as it is possible to suppress charge on the transfer medium, it is possible to effectively carry out an image formation after a cleaning of the transfer medium.

Meanwhile, the transfer medium cleaning roller, when viewed in cross-section of a central portion of a second roller in an axial direction, is disposed on a second roller side of a contact point at which an imaginary tangent line common to the second roller and a third roller makes contact with the third roller. Consequently, it is possible to set a nip width between a transfer belt cleaning roller and a transfer belt so as to be larger. As a result, as well as it being possible to reduce a transfer belt cleaning bias per unit area, it is possible to increase a time for which the transfer belt cleaning roller makes contact with the transfer belt. By this means, even in the event that the transfer belt cleaning bias is set so as to be comparatively high, it is possible to effectively clean the transfer belt while suppressing an effect on the transfer belt due to the cleaning bias.

Furthermore, as the heretofore described nip widths are made different from each other by adjusting a supporting position, a contact pressure, or a hardness, of each of the latent image carrier cleaning roller and the transfer medium cleaning roller, it is possible to easily carry out a setting of each nip width. Then, by the nip widths being set in such a way that the latent image carrier and the transfer medium can be cleaned at the same bias, it is possible to supply each bias by means of one and the same power supply. Consequently, as well as it being possible to reduce a number of parts, it is possible to effectively realize a miniaturization of the apparatus.

Furthermore, a transfer medium cleaning blade is provided which, being brought into abutment with the transfer medium, removes the liquid developer remaining on the transfer medium cleaned by the transfer medium cleaning roller. In this case, after a cleaning of solid toner from the liquid developer by the transfer medium cleaning roller, most of the liquid developer remaining on the transfer medium is liquid carrier. Consequently, as the transfer medium cleaning blade only removes the liquid carrier, it is possible to reduce a pressure at which the transfer medium cleaning blade abuts against the transfer medium. Although the transfer medium is generally softer than the latent image carrier, by the pressure at which the transfer medium cleaning blade abuts against the transfer medium being reduced, it is possible to suppress damage to the transfer medium, and achieve an increase in life span of the transfer medium.

### BRIEF DESCRIPTION OF THE DRAWINGS

The invention will be described with reference to the accompanying drawings, wherein like numbers reference like elements.

FIG. 1 schematically and partially shows one example of an embodiment of an image forming apparatus according to an embodiment of the invention.

FIG. 2A illustrates a nip width of a photoreceptor cleaning roller, using a fixed position method, while FIG. 2B illustrates a nip width of an intermediate transfer belt cleaning roller, using the fixed position method.

FIG. 3A illustrates the nip width of the photoreceptor cleaning roller, using a fixed load method, while FIG. 3B illustrates the nip width of the intermediate transfer belt cleaning roller, using the fixed load method.

FIG. 4 schematically and partially shows another example of the embodiment of the image forming apparatus according to an embodiment of the invention.

FIGS. 5A to 5C illustrate a nip width measuring method in a photoreceptor cleaning.

FIG. 6 shows a relationship between an applied bias and a non-cleaned amount (OD value) in an example 1.

FIG. 7 shows a relationship between an applied bias and a non-cleaned amount (OD value) in a comparison example 1.

FIG. 8 shows a relationship between an applied bias and a non-cleaned amount (OD value) in a comparison example 2.

FIG. 9 partially shows still another example of the embodiment of the invention.

### DESCRIPTION OF EXEMPLARY EMBODIMENTS

Hereafter, a description will be given, using the drawings, of embodiments of the invention.

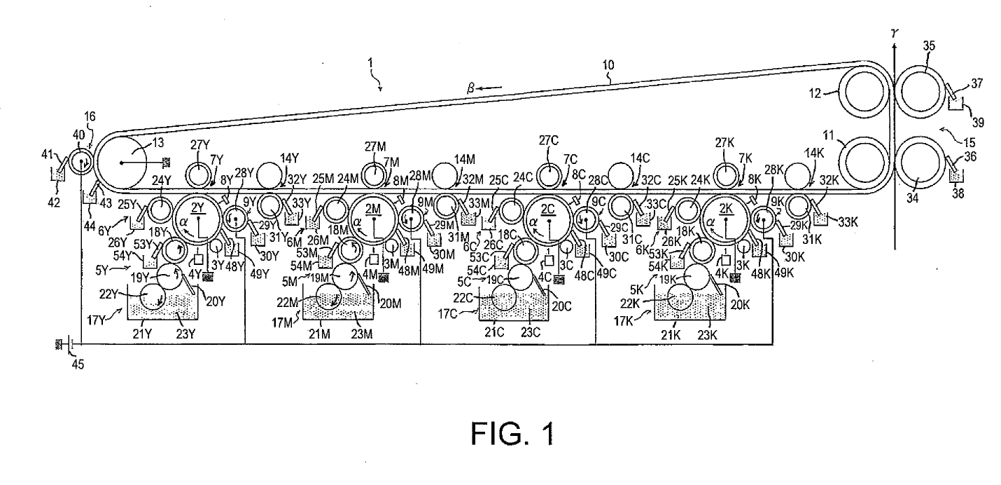

FIG. 1 schematically and partially shows one portion of one example of an embodiment of an image forming apparatus according to an embodiment of the invention.

As shown in FIG. 1, an image forming apparatus 1 of the example includes photoreceptors 2Y, 2M, 2C and 2K, disposed in tandem, which are yellow (Y), magenta (M), cyan (C), and black (K) latent image carriers. Herein r in each photoreceptor 2Y, 2M, 2C and 2K, 2Y represents a yellow photoreceptor, 2M a magenta photoreceptor, 2C a cyan photoreceptor, and 2K a black photoreceptor. Also, with respect to other members too, in the same way, Y, M, C and K for the individual colors are suffixed one to each of reference numbers of the members, representing a member of each color.

In the example shown in FIG. 1, each of the photoreceptors 2Y, 2M, 2C and 2K is configured of a photoreceptor drum. It is also possible to configure each photoreceptor 2Y, 2M, 2C and 2K as an endless belt.

Each of the photoreceptors 2Y, 2M, 2C and 2K is arranged in such a way as to rotate in an a direction shown by the arrow in FIG. 1, that is, in a clockwise direction in FIG. 1, when actuated. Charging devices 3Y, 3M, 3C and 3K are provided on peripheries of the photoreceptors 2Y, 2M, 2C and 2K, respectively. Exposure devices 4Y, 4M, 4C and 4K, developing devices 5Y, 5M, 5C and 5K (equivalent to a developing section according to the invention), photoreceptor squeeze devices 6Y, 6M, 6C and 6K, primary transfers 7Y, 7M, 7C and 7K (equivalent to a first transfer member according to the invention), neutralization devices 8Y, 8M, 8C and 8K, and photoreceptor cleaning devices 9Y, 9M, 9C and 9K are disposed, in order, in a rotation direction of the photoreceptors 2Y, 2M, 2C and 2K from the charging devices 3Y, 3M, 3C and 3K, respectively.

Also, the image forming apparatus 1 includes an endless intermediate transfer belt 10 which is an intermediate transfer medium. The intermediate transfer belt 10, although not shown, is formed as a three-layer structure of a flexible substrate of, for example, resin or the like, an elastic layer of rubber formed on a surface of the substrate, and a superficial layer formed on a surface of the elastic layer. Needless to say, this is not limiting. Then, the intermediate transfer belt 10, being stretched over a belt drive roller 11, to which a drive force of an unshown motor is transmitted, and a pair of driven rollers 12 and 13, is provided so as to be rotatable in a direction shown by an arrow β (a counterclockwise direction in FIG. 1). In this case, the belt drive roller 11 and one driven roller 12 are adjacently disposed spaced a predetermined distance away from each other in a moving direction (an upward direction from below in FIG. 1), shown by an arrow γ, of a recording material (not shown) such as paper conveyed thereto. Also, the belt drive roller 11 configures a first roller according to the invention, the driven roller 12 configures a second roller according to the invention, and furthermore, the driven roller 13 configures a third roller according to the invention.

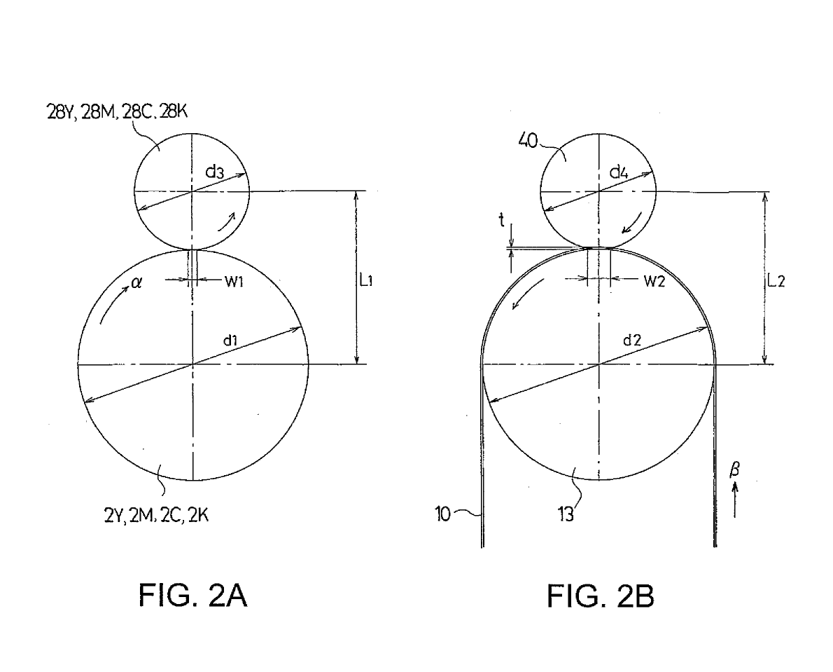

Furthermore, the belt drive roller 11 and the other driven roller 13 are disposed spaced apart in a tandem disposition direction of the photoreceptors 2Y, 2M, 2C and 2K. In this example, as shown in FIGS. 2A and 2B, a diameter d₂ of the driven roller 13 is set so as to be the same, or approximately the same, as a diameter d₁ of the photoreceptors 2Y, 2M, 2C and 2K (d₁=d₂ or d₁≈d₂).

Furthermore, although not shown, the intermediate transfer belt 10 is arranged in such a way as to be provided with a predetermined tension by a tension roller, taking up a slack. In the same way, although not shown, the tension roller is arranged in such a way as to be cleaned by a tension roller cleaning device.

In the image forming apparatus 1, the photoreceptors 2Y, 2M, 2C and 2K and the developing devices 5Y, 5M, 5C and 5K are disposed in the order of the colors Y, M, C and K from an upstream side (a left side in FIG. 1) in a moving direction β of the intermediate transfer belt 10, but it is possible to optionally set a disposition order of the colors Y, M, C and K.

Intermediate transfer belt squeeze devices 14Y, 14M, 14C and 14K are disposed respectively in vicinities of the primary transfers 7Y, 7M, 7C and 7K on downstream sides of the primary transfers 7Y, 7M, 7C and 7K in the rotation direction of the intermediate transfer belt 10. Furthermore, a secondary transfer 15 (equivalent to a second transfer member according to the invention) is provided on a belt drive roller 11 side of the intermediate transfer belt 10, and an intermediate transfer belt cleaning device 16 is provided on a driven roller 13 side of the intermediate transfer belt 10.

Although not shown, the image forming apparatus 1 of this example, in the same way as a heretofore known general image forming apparatus which carries out a secondary transfer, includes a recording material storage device, which stores a recording material such as, for example, paper, and a registration roller pair, which conveys and feeds the recording material from the recording material storage device to the secondary transfer 15, on an upstream side of the secondary transfer 15 in a recording material conveyance direction. Also, the image forming apparatus 1 includes a fixing device and a discharged paper tray, similarly on a downstream side of the secondary transfer 15 in the recording material conveyance direction.

Each of the charging devices 3Y, 3M, 3C and 3K is formed of a charging member such as, for example, a charging roller. A bias with the same polarity as a charge polarity of a liquid developer is applied to each charging device 3Y, 3M, 3C and 3K from an unshown power supply. Then, the charging devices 3Y, 3M, 3C and 3K are arranged in such a way as to charge the corresponding photoreceptors 2Y, 2M, 2C and 2K by means of the charging members.

Lights emitted from light emitting elements of the exposure devices 4Y, 4M, 4C and 4K are applied to the corresponding photoreceptors 2Y, 2M, 2C and 2K. By this means, a printing (a writing of an image) is carried out on each photoreceptor 2Y, 2M, 2C and 2K, and an electrostatic latent image of each color is formed on a surface of each corresponding photoreceptor 2Y, 2M, 2C and 2K.

The developing devices 5Y, 5M, 5C and 5K respectively include developer supply sections 17Y, 17M, 17C and 17K, developing rollers 18Y, 18M, 18C and 18K, developing roller cleaning blades 53Y, 53M, 53C and 53K, and developing roller cleaning blade recovered liquid reservoirs 54Y, 54M, 54C and 54K.

The developer supply sections 17Y, 17M, 17C and 17K respectively include anilox rollers 19Y, 19M, 19C and 19K, developer regulation blades 20Y, 20M, 20C and 20K, developer containers 21Y, 21M, 21C and 21K, and developer pumping rollers 22Y, 22M, 22C and 22K.

Each of the anilox rollers 19Y, 19M, 19C and 19K, being a cylindrical member, is a roller, on a surface of which a spiral groove (not shown) is formed finely and uniformly. Each of the anilox rollers 19Y, 19M, 19C and 19K is arranged in such a way as to rotate in a counterclockwise direction shown by the arrow in FIG. 1, in the same direction as that of each developing roller 18Y, 18M, 18C and 18K. It is also possible to arrange in such a way that each of the anilox rollers 19Y, 19M, 19C and 19K rotates in conjunction with each developing roller 18Y, 18M, 18C and 18K. That is, a rotation direction of the anilox rollers 19Y, 19M, 19C and 19K is not limited, but optional.

The developer regulation blades 20Y, 20M, 20C and 20K, being made of rubber such as, for example, urethane rubber, are brought into abutment with surfaces of the corresponding anilox rollers 19Y, 19M, 19C and 19K. Then, the developer regulation blades 20Y, 20M, 20C and 20K scrape off a liquid developer adhering to surfaces other than the grooves of the anilox rollers 19Y, 19M, 19C and 19K, respectively. Consequently, the anilox rollers 19Y, 19M, 19C and 19K supply the developing rollers 18Y, 18M, 18C and 18K with only a liquid developer adhering to interiors of their grooves.

The developer containers 21Y, 21M, 21C and 21K store liquid developers 23Y, 23M, 23C and 23K, respectively. Each of the liquid developers 23Y, 23M, 23C and 23K is one in which solid toner (toner particles: they are charged at an image formation time) is dispersed in a nonvolatile liquid carrier (referred to also as carrier oil. It is made from insulating oil such as, for example, silicone oil or mineral oil which prevents a charge of the toner from escaping).

The developer pumping rollers 22Y, 22M, 22C and 22K pump up the liquid developers 23Y, 23M, 23C and 23K in the developer containers 21Y, 21M, 21C and 21K, and supply them to the anilox rollers 19Y, 19M, 19C and 19K, respectively. Each of the developer pumping rollers 22Y, 22M, 22C and 22K is arranged in such a way as to rotate in a clockwise direction shown by the arrow in FIG. 1.

Each of the developing rollers 18Y, 18M, 18C and 18K has a cylindrical metallic shaft made of, for example, iron, and a conductive elastic layer such as, for example, a conductive urethane rubber or conductive resin layer is formed on an outer periphery thereof. The developing rollers 18Y, 18M, 18C and 18K are brought into contact with the photoreceptors 2Y, 2M, 2C and 2K, respectively, and arranged in such a way as to rotate in a counterclockwise direction shown by the arrow in FIG. 1. Then, the developing rollers 18Y, 18M, 18C and 18K convey the liquid developers of the colors corresponding to the corresponding photoreceptors 2Y, 2M, 2C and 2K, respectively.

The developing roller cleaning blades 53Y, 53M, 53C and 53K, being configured of, for example, rubber or the like which abuts against surfaces of the corresponding developing rollers 18Y, 18M, 18C and 18K, scrape off developer remaining on the developing rollers 18Y, 18M, 18C and 18K, respectively. Also, each developing roller cleaning blade recovered liquid reservoir 54Y, 54M, 54C and 54K accumulates the developer scraped off by each developing roller cleaning blade 53Y, 53M, 53C and 53K.

Although not shown, a compaction roller is disposed at predetermined intervals (in an order of μm) on an outer periphery of each of the developing rollers 18Y, 18M, 18C and 18K. The compaction rollers charge the corresponding developing rollers 18Y, 18M, 18C and 18K. By this means, the liquid developers 23Y, 23M, 23C and 23K on the developing rollers 18Y, 18M, 18C and 18K are pressed against the developing rollers 18Y, 18M, 18C and 18K. Developer remaining on each compaction roller is scraped off by each unshown compaction roller cleaner blade, and stored in each developer container 21Y, 21M, 21C and 21K.

Furthermore, although not shown, the image forming apparatus 1 of this example includes developer replenishing devices which replenish the developer containers 21Y, 21M, 21C and 21K with the liquid developers 23Y, 23M, 23C and 23K, respectively.

The photoreceptor squeeze devices 6Y, 6M, 6C and 6K respectively include squeeze rollers 24Y, 24M, 24C and 24K, squeeze roller cleaners 25Y, 25M, 25C and 25K, and squeeze roller cleaner recovered liquid reservoirs 26Y, 26M, 26C and 26K.

The squeeze rollers 24Y, 24M, 24C and 24K are rotated in a direction opposite to that of the photoreceptors 2Y, 2M, 2C and 2K (in the counterclockwise direction in FIG. 1), removing carrier oil from the liquid developer on the photoreceptors 2Y, 2M, 2C and 2K, respectively.

Also, the squeeze roller cleaners 25Y, 25M, 25C and 25K scrape off carrier oil remaining on the corresponding squeeze rollers 24Y, 24M, 24C and 24K. Furthermore, the squeeze roller cleaner recovered liquid reservoirs 26Y, 26M, 26C and 26K accumulate the carrier oil scraped off by the corresponding squeeze roller cleaners 25Y, 25M, 25C and 25K.

The primary transfers 7Y, 7M, 7C and 7K include primary transfer backup rollers 27Y, 27M, 27C and 27K which bring the intermediate transfer belt 10 into contact with the photoreceptors 2Y, 2M, 2C and 2K, respectively. A voltage with a polarity opposite to a charge polarity of the toner particles is applied to the backup rollers 27Y, 27M, 27C and 27K, and toner images (liquid developer images) of the colors on the photoreceptors 2Y, 2M, 2C and 2K are primarily transferred to the intermediate transfer belt 10.

Also, the neutralization devices BY, 8M, 8C and 8K remove charges remaining in the photoreceptors 2Y, 2M, 2C and 2K respectively, after the primary transfer.

The photoreceptor cleaning devices 9Y, 9M, 9C and 9K respectively include photoreceptor cleaning rollers 28Y, 28M, 28C and 28K, photoreceptor cleaning roller cleaners 29Y, 29M, 29C and 29K, photoreceptor cleaning roller cleaner recovered liquid reservoirs 30Y, 30M, 30C and 30K, photoreceptor cleaning blades 48Y, 48M, 48C and 48K, and photoreceptor cleaning blade recovered liquid reservoirs 49Y, 49M, 49C and 49K.

Each photoreceptor cleaning roller 28Y, 28M, 28C and 28K is formed of a conductive elastomer such as conductive rubber. As shown in FIG. 2A, the photoreceptor cleaning rollers 28Y, 28M, 28C and 28K are pressed into contact with the photoreceptors 2Y, 2M, 2C and 2K, respectively, at a predetermined nip width w₁. Then, each photoreceptor cleaning roller 28Y, 28M, 28C and 28K is rotated in a direction opposite to that of each photoreceptor 2Y, 2M, 2C and 2K (the counterclockwise direction in FIG. 1), and removes a remaining liquid developer on each photoreceptor 2Y, 2M, 2C and 2K after a transfer. Also, the photoreceptor cleaning roller cleaners 29Y, 29M, 29C and 29K scrape off a liquid developer remaining on the corresponding photoreceptor cleaning rollers 28Y, 28M, 28C and 28K. Furthermore, the photoreceptor cleaning roller cleaner recovered liquid reservoirs 30Y, 30M, 30C and 30K accumulate the liquid developer scraped off by the corresponding photoreceptor cleaning roller cleaners 29Y, 29M, 29C and 29K. Furthermore, the photoreceptor cleaning blades 48Y, 48M, 48C and 48K remove carrier oil remaining on the photoreceptors 2Y, 2M, 2C and 2K after a cleaning by the photoreceptor cleaning rollers 28Y, 28M, 28C and 28K. Furthermore, the photoreceptor cleaning blade recovered liquid reservoirs 49Y, 49M, 49C and 49K collect and accumulate the carrier oil which the photoreceptor cleaning blades 48Y, 48M, 48C and 48K have scraped off the photoreceptors 2Y, 2M, 2C and 2K, respectively.

The intermediate transfer belt squeeze devices 14Y, 14M, 14C and 14K respectively include intermediate transfer belt squeeze rollers 31Y, 31M, 31C and 31K, intermediate transfer belt squeeze roller cleaners 32Y, 32M, 32C and 32K, and intermediate transfer belt squeeze roller cleaner recovered liquid reservoirs 33Y, 33M, 33C and 33K.

The intermediate transfer belt squeeze rollers 31Y, 31M, 31C and 31K collect carrier oil of the corresponding colors on the intermediate transfer belt 10. Also, the intermediate transfer belt squeeze roller cleaners 32Y, 32M, 32C and 32K scrape off the carrier oil collected on the intermediate transfer belt squeeze rollers 31Y, 31M, 31C and 31K, respectively. Furthermore, the intermediate transfer belt squeeze roller cleaner recovered liquid reservoirs 33Y, 33M, 33C and 33K accumulate the carrier oil scraped off by the intermediate transfer belt squeeze roller cleaners 32Y, 32M, 32C and 32K, respectively.

The secondary transfer 15 includes a pair of secondary transfer rollers which are disposed spaced a predetermined distance away from each other in the recording material moving direction. A secondary transfer roller, of the pair of secondary transfer rollers, disposed on an upstream side in the recording material moving direction is an upstream side secondary transfer roller 34. The upstream side secondary transfer roller 34 can be pressed into contact with the belt drive roller 11 through the intermediate transfer belt 10. Also, a secondary transfer roller, of the pair of secondary transfer rollers, disposed on a downstream side in the recording material moving direction is a downstream side secondary transfer roller 35. The downstream side secondary transfer roller 35 can be pressed into contact with the driven roller 12 through the intermediate transfer belt 10. That is, the upstream and downstream side secondary transfer rollers 34 and 35 are arranged in such a way as to bring the recording material into contact with the intermediate transfer belt 10 stretched over the belt drive roller 11 and the driven roller 12, respectively, and secondarily transfer a color toner image (a liquid developer image) on the intermediate transfer belt 10, into which the toner images of the colors are combined, to the unshown recording material. In this case, the belt drive roller 11 and the driven roller 12 function as backup rollers of the secondary transfer rollers 34 and 35 respectively, at a secondary transfer time.

Consequently, the recording material conveyed to the secondary transfer 15 is brought into close contact with the intermediate transfer belt 10 (a long nip condition) in a predetermined moving area of the recording material from a position of being pressed into contact (a nip starting position) with the upstream side secondary transfer roller 34 and the belt drive roller 11 to a position of being released (a nip finishing position) from the downstream side secondary transfer roller 35 and the driven roller 12. By this means, as a full-color toner image on the intermediate transfer belt 10 is secondarily transferred to the recording material over a predetermined time in the long nip condition, a good secondary transfer is carried out. In this way, the secondary transfer 15 of this example carries out the secondary transfer by means of a long nip transfer system. Consequently, in the invention, the long nip transfer system is defined as a system wherein, by pressing the intermediate transfer belt 10 stretched between a plurality of rollers spaced a predetermined distance apart (that is, in this example, the belt drive roller 11 and the driven roller 12) against the plurality of rollers by means of one or more of transfer rollers (that is, in this example, the upstream side secondary transfer roller 34 and the downstream side secondary transfer roller 35), a transfer is carried out using a transfer nip of a predetermined length formed between the plurality of rollers.

Also, the secondary transfer 15 includes secondary transfer roller cleaners 36 and 37, and secondary transfer roller cleaner recovered liquid reservoirs 38 and 39 on the pair of secondary transfer rollers 34 and 35, respectively. The secondary transfer roller cleaners 36 and 37 scrape off and remove developer remaining on surfaces of the secondary transfer rollers 34 and 35 respectively, after the secondary transfer. Also, the secondary transfer roller cleaner recovered liquid reservoirs 38 and 39 accumulate the developer scraped off from the secondary transfer rollers 34 and 35 by the secondary transfer roller cleaners 36 and 37, respectively.

The intermediate transfer belt cleaning device 16 includes an intermediate transfer belt cleaning roller 40, a roller cleaning blade 41, a roller cleaning blade recovered liquid reservoir 42, an intermediate transfer belt cleaning blade 43, and an intermediate transfer belt cleaning blade recovered liquid reservoir 44.

The intermediate transfer belt cleaning roller 40 is formed of a conductive elastomer such as conductive rubber. In this example, as shown in FIGS. 2A and 2B, a diameter d₄ of the intermediate transfer belt cleaning roller 40 is set so as to be the same, or approximately the same, as a diameter d₃ of each photoreceptor cleaning roller 28Y, 28M, 28C and 28K (d₃=d₄ or d₃≈d₄). Also, a hardness of the intermediate transfer belt cleaning roller 40 is set so as to be the same, or approximately the same, as a hardness of the intermediate transfer belt 10.

Furthermore, the intermediate transfer belt cleaning roller 40 is pressed into contact with the intermediate transfer belt 10 at a predetermined nip width w₂. In this case, the nip width w₂ of the intermediate transfer belt cleaning roller 40 is set so as to be larger than the nip width w₁ of each photoreceptor cleaning roller 28Y, 28M, 28C and 28K (w₁<w₂). In this case, in this example, a relationship in magnitude between the nip widths w₁ and w₂ is set by making a position L₁, in which each photoreceptor cleaning roller 28Y, 28M, 28C and 28K supports each photoreceptor 2Y, 2M, 2C and 2K, different from a position L₂ in which the intermediate transfer belt cleaning roller 40 supports the driven roller 13. In this case, as the roller supporting positions L₁ and L₂ are fixed positions, the nip widths w₁ and w₂ of this example are determined by a roller fixed position method. In FIGS. 2A and 2B, by a thickness t of the intermediate transfer belt 10 being involved, L₂ is slightly much larger than L₁, but the two nip widths w₁ and w₂ are set so as to be w₁<w₂.

Then, the intermediate transfer belt cleaning roller 40 is rotated in a direction opposite to that of the intermediate transfer belt 10 (a clockwise direction in FIG. 2B), scraping off developer (mainly, solid toner) remaining on the surface of the intermediate transfer belt 10 after the secondary transfer. In this case, the driven roller 13 also functions as a backup roller at an intermediate transfer belt cleaning time. Also, the roller cleaning blade recovered liquid reservoir 42 collects and accumulates the developer scraped off the intermediate transfer belt 10 by the intermediate transfer belt cleaning roller 40. Furthermore, the intermediate transfer belt cleaning blade 43 removes carrier oil remaining on the intermediate transfer belt 10 after a cleaning by the intermediate transfer belt cleaning roller 40. Furthermore, the intermediate transfer belt cleaning blade recovered liquid reservoir 44 collects and accumulates the carrier oil scraped off the intermediate transfer belt 10 by the intermediate transfer belt cleaning blade 43.

Also, photoreceptor cleaning biases for cleaning the photoreceptors 2Y, 2M, 2C and 2K are applied to the photoreceptor cleaning rollers 28Y, 28M, 28C and 28K, respectively. Also, an intermediate transfer belt cleaning bias for cleaning the intermediate transfer belt 10 is applied to the intermediate transfer belt cleaning roller 40. That is, the photoreceptor cleaning rollers 28Y, 28M, 28C and 28K, and the intermediate transfer belt cleaning roller 40 are all configured as roller bias cleaners. Then, the photoreceptor cleaning biases and the intermediate transfer belt cleaning bias are biases capable of removing solid toner from the liquid developer from the photoreceptors 2Y, 2M, 2C and 2K, and the intermediate transfer belt 10, respectively, after a transfer. In this case, in the image forming apparatus 1 of this example, as shown in FIG. 1, the photoreceptor cleaning biases and intermediate transfer belt cleaning bias are all applied at the same voltage from one and the same power supply 45.

According to the image forming apparatus 1 of this example configured in this way, in the same way as with the heretofore known one heretofore described, solid toner adheres to the intermediate transfer belt 10 with an adhesion greater than an adhesion to the photoreceptors 2Y, 2M, 2C and 2K, but it is possible to efficiently remove solid toner adhering to each photoreceptor 2Y, 2M, 2C and 2K after the primary transfer, and solid toner adhering to the intermediate transfer belt 10 after the secondary transfer, using the biases applied to each photoreceptor cleaning roller 28Y, 28M, 28C and 28K, and the intermediate transfer belt cleaning roller 40.

In particular, the nip width w₂ of the intermediate transfer belt cleaning roller 40 is set so as to be larger than the nip width w₁ of each photoreceptor cleaning roller 28Y, 28M, 28C and 28K. By this means, it is possible to set a solid toner nip transit time (a solid toner electrophoresis time) for the intermediate transfer belt 10, which has a high solid toner adhesion and is hard to clean, so as to be longer than a solid toner nip transit time for each photoreceptor 2Y, 2M, 2C and 2K. Consequently, it is possible to more effectively remove solid toner on the intermediate transfer belt 10 which is hard to remove. Also, as it is possible, by this means, to make the bias applied to the intermediate transfer belt cleaning roller 40 comparatively low, it is possible to suppress an effect on the intermediate transfer belt 10 due to the bias. As a result, as a charging of the intermediate transfer belt 10 is suppressed, it is possible to effectively carry out an image formation after a cleaning of the intermediate transfer belt 10.

Furthermore, as the heretofore described nip widths w₁ and w₂ are made different from each other by adjusting the photoreceptor cleaning roller 28Y, 28M, 28C and 28K and intermediate transfer belt cleaning roller 40 supporting positions, it is possible to easily carry out a setting of the nip widths w₁ and w₂. Then, by setting the nip widths w₁ and w₂ in such a way that the photoreceptors 2Y, 2M, 2C and 2K, and the intermediate transfer belt 10 can be cleaned at the same bias, it is possible to supply each bias using one and the same power supply 45. Consequently, as well as it being possible to reduce a number of parts, it is possible to effectively realize a miniaturization of the apparatus.

Furthermore, the intermediate transfer belt cleaning blade 43 is provided which, being brought into abutment with the intermediate transfer belt 10, removes a liquid developer remaining on the intermediate transfer belt 10 after a cleaning by the intermediate transfer belt cleaning roller 40. In this case, most of the liquid developer remaining on the intermediate transfer belt 10 is liquid carrier after a cleaning of the solid toner from the liquid developer by the intermediate transfer belt cleaning roller 40. Consequently, as the intermediate transfer belt cleaning blade 43 simply removes the liquid carrier, it is possible to reduce a pressure at which the intermediate transfer belt cleaning blade 43 abuts against the intermediate transfer belt 10. Although the intermediate transfer belt 10 is generally softer than each photoreceptor, damage to the intermediate transfer belt 10 being suppressed by the pressure at which the intermediate transfer belt cleaning blade 43 abuts against the intermediate transfer belt 10 being reduced, it is possible to achieve an increase in life span of the intermediate transfer belt 10.

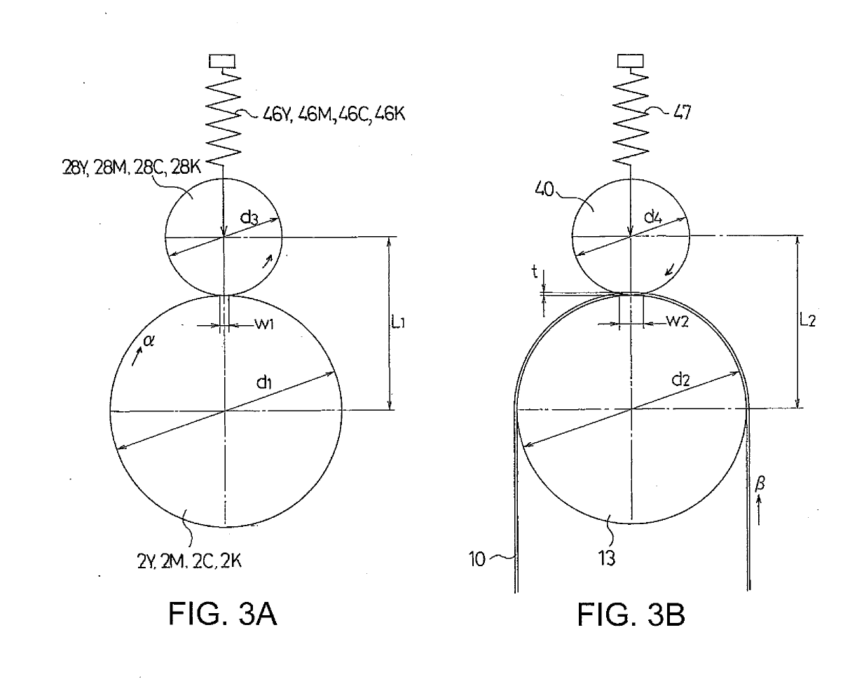

FIGS. 3A and 3B are partial diagrammatic views which are similar to FIGS. 2A and 2B, respectively, schematically showing another example of the embodiment of the image forming apparatus according to the invention.

In an image forming apparatus 1 of this example, as shown in FIG. 3A, photoreceptor cleaning roller biasing units 46Y, 46M, 46C and 46K are provided which, being formed of, for example, springs or the like, bias the photoreceptor cleaning rollers 28Y, 28M, 28C and 28K toward the corresponding photoreceptors 2Y, 2M, 2C and 2K, respectively. Consequently, the nip width w₁ between each photoreceptor cleaning roller 28Y, 28M, 28C and 28K, and each photoreceptor 2Y, 2M, 2C and 2K, is set depending on a bias force of each photoreceptor cleaning roller biasing unit 46Y, 46M, 46C and 46K.

Also, as shown in FIG. 3B, an intermediate transfer belt cleaning roller biasing unit 47 is provided which, being formed of, for example, a spring or the like, biases the intermediate transfer belt cleaning roller 40 toward the intermediate transfer belt 10. Consequently, a nip width w₂ (>w₁) between the intermediate transfer belt cleaning roller 40 and the intermediate transfer belt 10 is set depending on a bias force of the intermediate transfer belt cleaning roller biasing unit 47. In this case, as the bias force of each roller is a fixed load, the nip widths w₁ and w₂ in this example are determined by a roller fixed load method.

In this example, as each photoreceptor cleaning roller biasing unit 46Y, 46M, 46C and 46K, and the intermediate transfer belt cleaning roller biasing unit 47 are provided, a number of parts is increased in comparison with the heretofore described example. Other configurations and working effects of the image forming apparatus 1 of this example are the same as those of the heretofore described example.

As a method of setting the heretofore described two nip widths w₁ and w₂ so as to be w₁<w₂, in the same way as in each heretofore described example, a diameter d₃ of each photoreceptor cleaning roller 28Y, 28M, 28C and 28K is set so as to be the same, or approximately the same, as a diameter d₄ of the intermediate transfer belt cleaning roller 40. Furthermore, a hardness of the intermediate transfer belt cleaning roller 40 is set so as to be lower than a hardness of diameter d₄ each of photoreceptor cleaning roller 28Y, 28M, 28C and 28K. By this means too, it is possible to set the two nip widths w₂ and w₁ so as to be w₁<w₂. Consequently, it is possible to obtain the same working effect as that of the heretofore described first example by applying the diameter d₃ of each photoreceptor cleaning roller 28Y, 28M, 28C and 28K, and the diameter d₄ of the intermediate transfer belt cleaning roller 40, to the image forming apparatus 1 of the heretofore described example shown in FIG. 1.

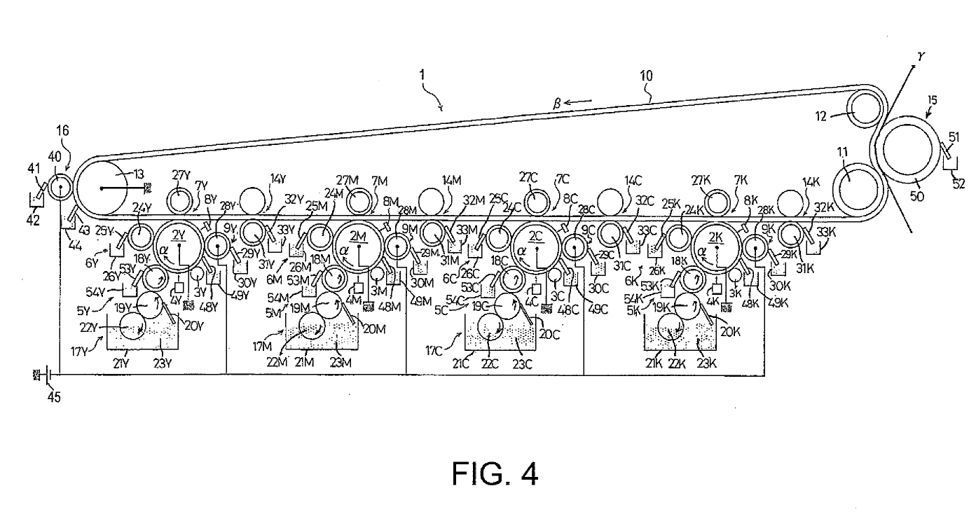

FIG. 4 is a diagrammatic view which is similar to FIG. 1, schematically showing one portion of another example of the embodiment of the image forming apparatus according to the invention.

As shown in FIG. 4, with an image forming apparatus 1 of this example, the intermediate transfer belt 10 stretched between the belt drive roller 11 and the driven roller 12 is pressed against the belt drive roller 11 and the driven roller 12 by one secondary transfer roller 50. That is, the secondary transfer roller 50, being disposed between the belt drive roller 11 and the driven roller 12, presses the intermediate transfer belt 10 in such a way as to push it into a space between the belt drive roller 11 and the driven roller 12 inside a tangent line common to the belt drive roller 11 and the driven roller 12. By this means, a long nip transfer system is configured.

Also, the transfer roller 50 is also provided with the secondary transfer roller cleaner 51 and the secondary transfer roller cleaner recovered liquid reservoir 52, in the same way as heretofore described.

Other configurations and working effects of the image forming apparatus 1 of this example are the same as those of the examples shown one in each of FIGS. 1 to 3.

Next, a description will be given of specific examples of the invention.

One specific example of each of a photoreceptor and an intermediate transfer belt, which is an intermediate transfer medium, in the image forming apparatus of the embodiment according to the invention is shown in Table 2.

TABLE 2

| Photoreceptor | Photosensitive layer | | Amorphous silicon |
|---|---|---|---|
| | Cleaning | Material | Conductive urethane rubber + |
| | roller | | superficial layer fluorine resin coat |
| | | Resistance | Log7Ω |
| | | Roller diameter | φ20 |
| | | Nip width | 2 mm |
| | | | (In case of fixed position method) |
| | | | Biting amount 0.1 mm |
| | | | (In case of fixed load method) |
| | | | Bias load 1 kgf |
| | | Rubber hardness | JIS-A55° |
| | | Applied voltage | −300 to −1000 V |
| Intermediate | Belt | | Substrate: polyimide, thickness 100 μm |
| transfer medium | | | Elastic layer: conductive urethane |
| | | | rubber, thickness 200 μm, hardness |
| | | | JIS-A30° |
| | | | Superficial layer: fluorine resin coat, |
| | | | thickness 10 μm |
| | Cleaning | Material | Conductive urethane rubber + |
| | roller | | superficial layer fluorine resin coat |
| | | Resistance | Log7Ω |
| | | Roller diameter | φ20 |
| | | Nip width | 5 mm |
| | | | (In case of fixed position method) |
| | | | Biting amount 0.3 mm |
| | | | (In case of fixed load method) |
| | | | Bias load 4 kgf |
| | | Rubber hardness | JIS-A30° |
| | | Applied voltage | −300 to −1000 V |

As shown in Table 2, a photoreceptor, using amorphous silicon as a photosensitive layer, in the same way as heretofore known, is set so as to have an outer diameter of φ 40 mm. Also, a photoreceptor cleaning roller, using conductive urethane rubber as a material, is formed by providing a superficial layer fluorine resin coat on a surface of the conductive urethane rubber. At this time, as well as a resistance being set at Log 7Ω, a roller diameter d₃ is set at φ20 mm. Also, a nip width w₁ between the photoreceptor and the photoreceptor cleaning roller is set at 2 mm. In order to obtain the nip width w₁, a biting amount is set at 0.1 mm in the fixed position method. Also, a bias load is set at 1 kgf in the fixed load method. Furthermore, a hardness of the photoreceptor cleaning roller (a hardness of the conductive urethane rubber) is set at JIS-A55°. Furthermore, a bias applied to the photoreceptor cleaning roller is set at −300 to −1000V.

Also, the intermediate transfer belt 10 is formed as a three-layer structure of a substrate, an elastic layer on a surface of the substrate, and a superficial layer on a surface of the elastic layer. Polyimide of 100 μm thickness is used as the substrate. Also, comparatively soft conductive urethane rubber of 200 μm thickness and JIS-A30° hardness is used as the elastic layer. Furthermore, a fluorine resin coat of 10 μm thickness is used as the superficial layer. Furthermore, the intermediate transfer belt cleaning roller, as a material of which conductive urethane rubber is used, is formed by providing a superficial layer fluorine resin coat on a surface of the conductive urethane rubber. At this time, as well as a resistance being set at Log 7Ω, a roller diameter d₄ is set at φ20 mm. Meanwhile, a diameter of the driven roller 13 is set at φ 40 mm. Then, a nip width w₂ between the intermediate transfer belt 10 and the intermediate transfer belt cleaning roller is set at 5 mm. In order to obtain the nip width w₂, a biting amount is set at 0.3 mm in the fixed position method. Also, a bias load is set at 4 kgf in the fixed load method. Furthermore, a hardness of the intermediate transfer belt cleaning roller (a hardness of the conductive urethane rubber) is set at JIS-A30°. Furthermore, a bias applied to the intermediate transfer belt cleaning roller is set at −300 to −1000V.

Next, a description will be given of an example 1, and comparison examples 1 and 2, in which an experiment has been made on a cleaning property in the image forming apparatus 1 of the embodiment of the invention. A color printer LP9000C made by Seiko Epson Corporation is used in the experiment. In this case, a portion of the color printer LP9000C differing from the image forming apparatus 1 shown in FIG. 1 has been modified.

Firstly, conditions of a photoreceptor cleaning and an intermediate transfer belt cleaning, which have been used in the experiment, are shown in Table 3 for the example 1, and in Table 4 and Table 5 for the comparison examples 1 and 2.

TABLE 3

| | | | Photoreceptor | Intermediate transfer belt |
|---|---|---|---|---|
| | | | cleaning | cleaning |
| Member to be cleaned | | | Amorphous silicon | Substrate: polyimide 100 μm |
| | | | φ78 | Elastic layer: conductive |
| | | | | urethane rubber 200 μm, |
| | | | | JIS-A30° |
| | | | | Superficial layer: fluorine |
| | | | | resin coat 10 μm |
| Bias | | (V) | −300 | Experimental range: −600 |
| | | | (Settable range: −200 | to −1400 |
| | | | to −400) | (Good range: −800 to −1200) |
| Roller | Diameter | (mm) | φ20 | φ25 |
| | Wall thickness | (mm) | t2.5 | t5 |
| | Rubber hardness | (JIS-A) | 30° | 30° |
| | Resistance | (Ω) | Log7 | Log7 |

| Contact method | | Fixed position method | Fixed load method |
|---|---|---|---|
| | | Bite 0.1 mm | 10 kgf |
| Nip width | (mm) | 2 | 4 |
| Length in axial direction | (mm) | 368 | 352 |

In the example 1 shown in Table 3, with respect to the photoreceptor cleaning, a photoreceptor which is a member to be cleaned, using amorphous silicon as a photosensitive layer, is set so as to have a diameter of φ 78 mm, Also, for a photoreceptor cleaning roller, a diameter is set at φ 20 mm, a rubber wall thickness t of a superficial layer at 2.5 mm, a rubber hardness at 30° on JIS-A scale, and an electrical resistance at Log 7Ω. A bias applied between the photoreceptor and the photoreceptor cleaning roller is set at −300V (in the present experimental apparatus, a bias settable range is from −200 to −400V). A method of bringing the photoreceptor cleaning roller into contact with the photoreceptor is the fixed position method, and a biting amount is set at 0.1 mm. A nip width w_at this time is 2 mm. A length of a nip portion in an axial direction is 368 mm.

A description will be given of a nip width measuring method in the photoreceptor cleaning.

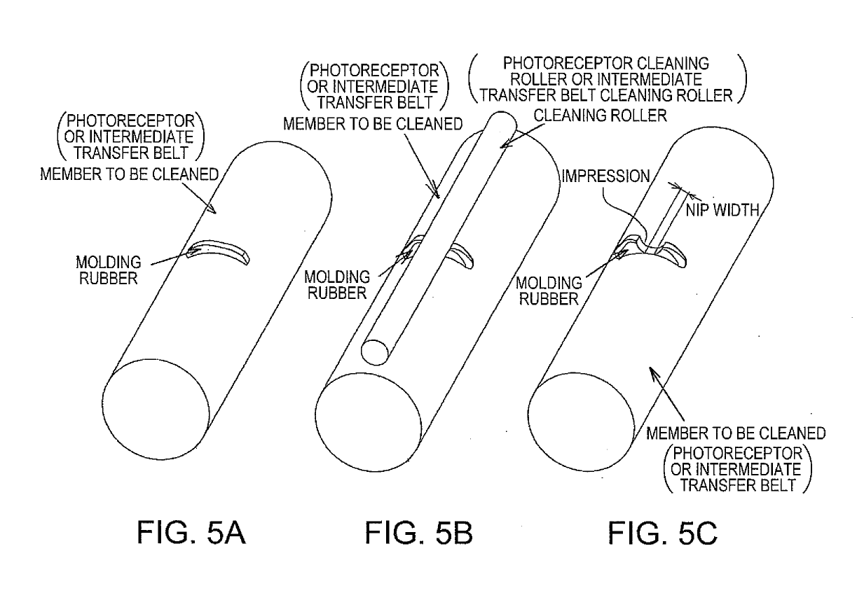

Firstly, as shown in FIG. 5A, an arc shaped molding rubber body of a predetermined width, which is formed of a material into which base paste and catalyst pastes are kneaded, is provided standing on the photoreceptor used in the experiment in a circumferential direction of the photoreceptor. This kneaded material is a GC Corporation's Exafine (trade name) injection type (hydrophilic vinyl silicon). Next, as shown in FIG. 5B, the photoreceptor cleaning roller is pressed in such a way that a direction of axis thereof becomes a direction of axis of the photoreceptor, until an amount by which the photoreceptor cleaning roller bites into the photoreceptor reaches 0.1 mm. Then, after leaving in this condition for three to six minutes, the photoreceptor cleaning roller is removed, as shown in FIG. 5C, and a width of a portion of an impression in the molding rubber body which corresponds to an outer peripheral surface of the photoreceptor is measured with a caliper. The width measured with the caliper is the nip width.

Also, with respect to the intermediate transfer belt cleaning, a substrate of an intermediate transfer belt which is a member to be cleaned is polyimide of 100 μm thickness, an elastic layer thereon is conductive urethane rubber of 200 μm thickness and 30° JIS-A hardness, and furthermore, a superficial layer thereon is a fluorine resin coat of 10 μm thickness. Also, a diameter of an intermediate transfer belt cleaning roller is set at φ 25 mm, a rubber wall thickness t of superficial layer at 5 mm, a rubber hardness at 30° on the JIS-A scale, and an electrical resistance at Log 7Ω. A belt cleaning bias setting range (experimental range) applied between the intermediate transfer belt and the intermediate transfer belt cleaning roller is from −600V to −1400V, and a good range (an OD value of 0.1 or less) in which it is possible to obtain a good cleaning is from −800V to −1200V. A method of bringing the intermediate transfer belt cleaning roller into contact with the intermediate transfer belt is the fixed load method, and a load of the roller is set at 10 kgf. A nip width w₂ at this time is 4 mm (w₁<w₂). A length of a nip portion in an axial direction is 352 mm.

A description will be given of a nip width measuring method in the intermediate transfer belt cleaning.

This nip width is measured by the heretofore described measuring method shown in FIGS. 5A to 5C. In this case, in the same way as heretofore described, a molding rubber body is provided standing on an intermediate transfer belt which, as well as being a member to be cleaned, is wound around the driven roller 13. The intermediate transfer belt cleaning roller is pressed against the molding rubber body at a load of 10 kgf until the intermediate transfer belt cleaning roller comes into contact with the intermediate transfer belt. The nip width is measured with a caliper, in the same way as heretofore described.

TABLE 4

| | | | Photoreceptor | Intermediate transfer belt |
|---|---|---|---|---|
| | | | cleaning | cleaning |
| Member to be cleaned | | | Amorphous silicon φ78 | Substrate: polyimide |
| | | | | 100 μm |
| | | | | Elastic layer: conductive |
| | | | | urethane rubber 200 μm, |
| | | | | JIS-A30° |
| | | | | Superficial layer: fluorine |
| | | | | resin coat 10 μm |
| Bias | | (V) | −300 | Experimental range: −600 |
| | | | (Settable range: −200 | to −1400 |
| | | | to −400) | No good area |
| Roller | Diameter | (mm) | φ20 | φ20 |
| | Wall thickness | (mm) | t2.5 | t2.5 |
| | Rubber hardness | (JIS-A) | 30° | 30° |
| | Resistance | (Ω) | Log7 | Log7 |

| Contact method | | Fixed position method | Fixed position method |
|---|---|---|---|
| | | Bite 0.1 mm | Bite 0.1 mm |
| Nip width | (mm) | W1 = 2 | W2 = 1.5 |
| Length in axial direction | (mm) | 368 | 352 |

In the comparison example 1 shown in Table 4, a photoreceptor cleaning is the same as in the heretofore described example 1. Also, with respect to an intermediate transfer belt cleaning, an intermediate transfer belt, which is a member to be cleaned, is the same as in the heretofore described example 1. Also, for an intermediate transfer belt cleaning roller, a diameter is set at +20 mm, a rubber wall thickness t of a superficial layer at 2.5 mm, a rubber hardness at 300 on the JIS-A scale, and an electrical resistance at Log 7ω. A belt cleaning bias setting range (experimental range) applied between the intermediate transfer belt and the intermediate transfer belt cleaning roller is from −600V to −1400V, and there exists no good range (OD value of 0.1 or less) in which it is possible to obtain a good cleaning. No bias is applied between the intermediate transfer belt and the intermediate transfer belt cleaning roller. A method of bringing the intermediate transfer belt cleaning roller into contact with the intermediate transfer belt is the fixed position method, and a biting amount of the roller is set at 0.1 mm. A nip width w₂ is 1.5 mm (w₁>w₂). A length of a nip portion in an axial direction is 352 mm.

TABLE 5

| | | | Photoreceptor | Intermediate transfer belt |
|---|---|---|---|---|
| | | | cleaning | cleaning |
| Member to be cleaned | | | Amorphous silicon | Substrate: polyimide 100 μm |
| | | | φ78 | Elastic layer: conductive |
| | | | | urethane rubber 200 μm, |
| | | | | JIS-A30° |
| | | | | Superficial layer: fluorine resin |
| | | | | coat 10 μm |
| Bias | | (V) | −300 | Experimental range: −600 |
| | | | (Settable range: −200 | to −1400 |
| | | | to −400) | (Good range: −800 to −1200) |
| Roller | Diameter | (mm) | φ25 | φ25 |
| | Wall thickness | (mm) | t5 | t5 |
| | Rubber hardness | (JIS-A) | 30° | 30° |
| | Resistance | (Ω) | Log7 | Log7 |

| Contact method | | Fixed load method | Fixed load method |
|---|---|---|---|
| | | 10 kgf | 10 kgf |
| Nip width | (mm) | W1 = 4.5 | W2 = 4 |
| Length in axial direction | (mm) | 368 | 352 |

In the comparison example 2 shown in FIGS. 5A to 5C, with respect to the photoreceptor cleaning, for a photoreceptor cleaning roller, a diameter is set at +25 mm, and a rubber wall thickness t of a superficial layer at 5 mm. A method of bringing the photoreceptor cleaning roller into contact with a photoreceptor is the fixed load method, and a load of the roller is set at 10 kgf. Other points regarding the photoreceptor cleaning are the same as in the heretofore described example 1. A nip width w₁ at this time is 4.5 mm. A length of a nip portion in an axial direction is 368 mm. Also, with respect to the intermediate transfer belt cleaning, this is the same as in the heretofore described example 1.

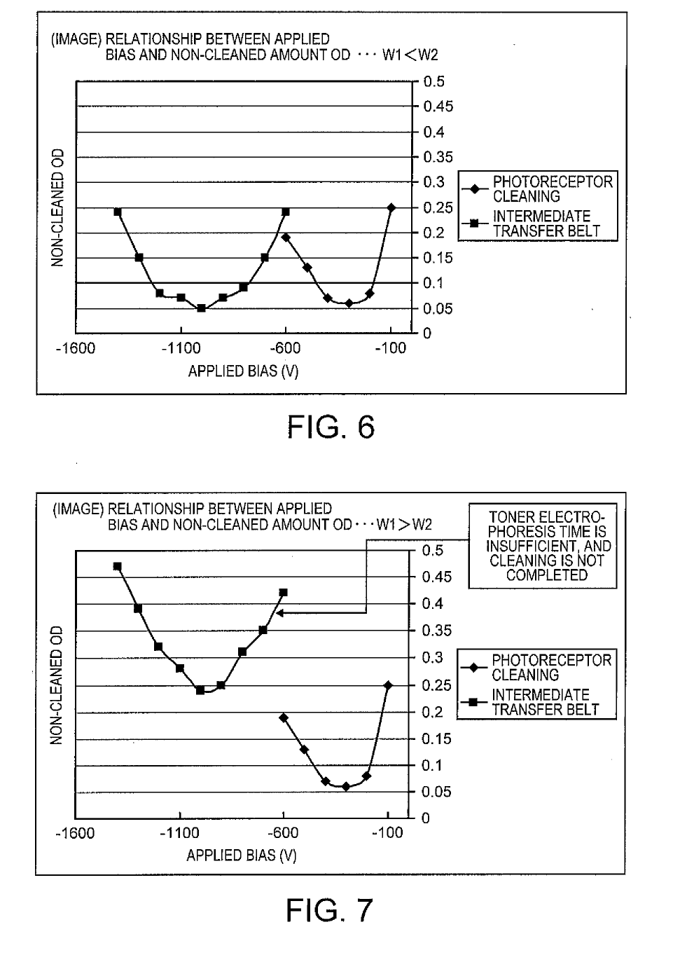

Non-cleaned amounts (OD values) in the example 1 and the comparison examples 1 and 2 are shown in FIGS. 6 to 8, respectively.

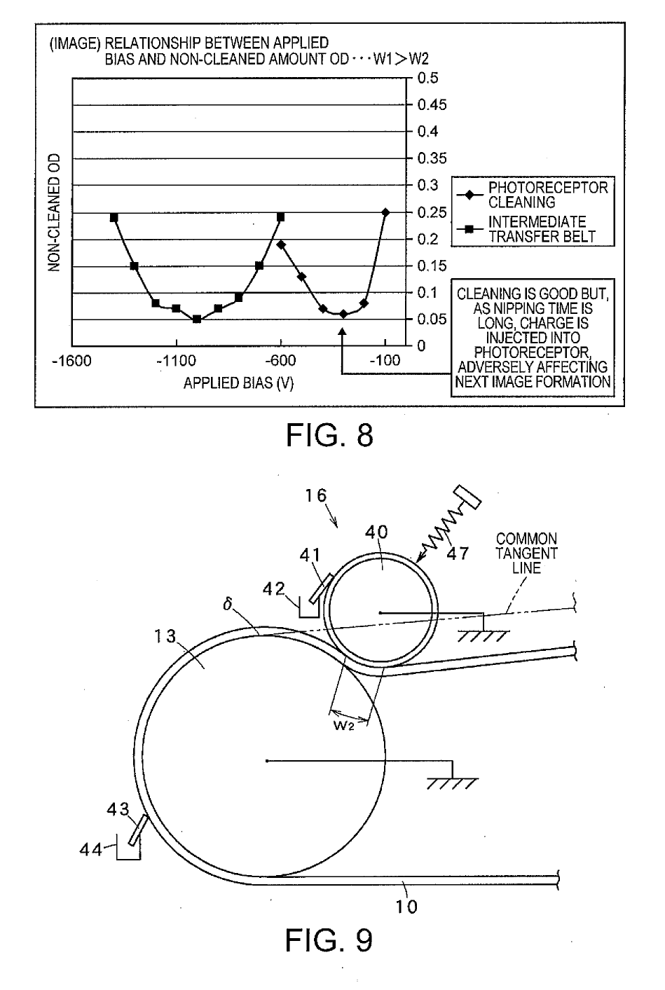

As shown in FIG. 6, in the example 1, in both the photoreceptor cleaning and the intermediate transfer belt cleaning, an OD value is comparatively low, and a cleaning is good. Meanwhile, as shown in FIG. 7, in the comparison example 1, the OD value in the photoreceptor cleaning is comparatively low, and it is possible to obtain a good cleaning property, while the OD value in the intermediate transfer belt cleaning is comparatively high, and it is not possible to obtain a good cleaning property. Also, as shown in FIG. 8, in the comparison example 2, in the same way as in the example 1, in both the photoreceptor cleaning and the intermediate transfer belt cleaning, it is possible to obtain a good cleaning property. However, in the comparison example 2, as a time of nipping between the photoreceptor and the photoreceptor cleaning roller is long, an electrical charge is injected into the photoreceptor. For this reason, it adversely affects a next image formation.

From the above experimental results, it has been confirmed that it is possible to obtain a desired advantage by means of the image forming apparatus of the embodiment of the invention.

FIG. 9 partially shows still another example of the embodiment of the invention.

In an image forming apparatus 1 of this example, as shown in FIG. 9, the intermediate transfer belt cleaning roller 40 is disposed on a driven roller 12 side of a contact point δ at which an imaginary tangent line (shown by the two-dot chain line) common to the secondary transfer 15 side driven roller 12 and the intermediate transfer belt cleaning device 16 side driven roller 13 makes contact with the driven roller 13.

That is, the intermediate transfer belt cleaning roller 40 is pressed into contact on the driven roller 12 side of the contact point δ of the intermediate transfer belt 10 when viewed in cross-section of a central portion of the driven roller 12 in an axial direction. By the intermediate transfer belt cleaning roller 40 being pressed into contact with the intermediate transfer belt 10 in this way, the intermediate transfer belt 10 assumes a position, shown by the solid line, inside the common tangent line shown by the two-dot chain line. Consequently, the intermediate transfer belt 10 is wound partially around the intermediate transfer belt cleaning roller 40. By this means, the intermediate transfer belt 10 has a nip width w₂ between the intermediate transfer belt cleaning roller 40 and the intermediate transfer belt 10 set so as to be larger than in the heretofore described examples. Also, an amount by which the intermediate transfer belt 10 is wound around the driven roller 13 is set so as to be larger than in the heretofore described examples. The driven roller 13, in the same way as in the heretofore described examples, functions as a backup roller of the intermediate transfer belt cleaning roller 40.

Other configurations of the image forming apparatus 1 of this example are the same as those of the heretofore described examples.

According to the image forming apparatus 1 of this example, the nip width w₂ between the intermediate transfer belt cleaning roller 40 and the intermediate transfer belt 10 is set so as to be larger than in the heretofore described examples. Consequently, as well as it being possible to reduce an intermediate transfer belt 10 cleaning bias per unit area, it is possible to increase a time for which the intermediate transfer belt cleaning roller 40 makes contact with the intermediate transfer belt 10. By this means, even in the event that the intermediate transfer belt 10 cleaning bias is set so as to be comparatively high, it is possible to effectively clean the intermediate transfer belt 10 while suppressing an effect on the intermediate transfer belt 10 due to the cleaning bias.

Meanwhile, in the photoreceptor cleaning, as the nip width w₁ between each photoreceptor 2Y, 2M, 2C and 2K, and each photoreceptor cleaning roller 28Y, 28M, 28C and 28K is comparatively small, as well as each photoreceptor 2Y, 2M, 2C and 2K cleaning bias per unit area increasing, a time for which each photoreceptor cleaning roller 28Y, 28M, 28C and 28K makes contact with each photoreceptor 2Y, 2M, 2C and 2K decreases. At this time, by setting each photoreceptor 2Y, 2M, 2C and 2K cleaning bias so as to be lower than the intermediate transfer belt 10 cleaning bias, even in the event that each photoreceptor 2Y, 2M, 2C and 2K cleaning bias per unit area is high, it is possible to effectively clean each photoreceptor 2Y, 2M, 2C and 2K while suppressing an effect on each photoreceptor 2Y, 2M, 2C and 2K due to the cleaning bias.

The intermediate transfer medium can also be formed of a cylindrical drum, apart from the endless intermediate transfer belt. The invention is capable of various other modifications within the scope of the matters described in the claims.

The entire disclosure of Japanese Patent Application Nos: 2008-64087, filed Mar. 13, 2008 and 2008-239657, filed Sep. 18, 2008 are expressly incorporated by reference herein.

What is claimed is:

1. An image forming apparatus comprising:
a latent image carrier on which an latent image is formed;
a developing section that develops the latent image using a liquid developer, and forms an image on the latent image carrier;
a transfer medium to which the image on the latent image carrier is transferred;
a first transfer member that transfers the image on the latent image carrier to the transfer medium;
a second transfer member that transfers the image on the transfer medium to a recording material;
a latent image carrier cleaning roller that makes contact with the latent image carrier, forms a nip having a first nip width in a moving direction of the latent image carrier, has a latent image carrier cleaning bias applied thereto, and cleans the latent image carrier of which the image of the latent image carrier has been transferred to the transfer medium; and
a transfer medium cleaning roller that has a transfer medium cleaning bias applied thereto, cleans the transfer medium on which has been transferred to the recording material makes contact with the transfer medium, and forms a second nip width that is larger than the first nip width in a moving direction of the transfer medium.

2. The image forming apparatus according to claim 1, wherein
the transfer medium is a transfer belt, and
the second transfer member is a transfer roller that is pressed, through the transfer belt stretched between a first roller and a second roller, against the first roller or the second roller.

3. The image forming apparatus according to claim 2, further comprising:
a third roller that has the transfer belt wound therearound, and makes contact with the transfer medium cleaning roller through the transfer belt, wherein
the transfer medium cleaning roller, when viewed in cross-section of a central portion of the second roller in an axial direction, is disposed on a second roller side of a contact point at which an imaginary tangent line common to the second roller and the third roller makes contact with the third roller.

4. The image forming apparatus according to claim 1, wherein
the latent image carrier cleaning bias is applied to the latent image carrier cleaning roller by a power supply, the transfer medium cleaning bias is applied to the transfer medium cleaning roller by the power supply.

5. The image forming apparatus according to claim 1, wherein
the transfer medium cleaning roller and the latent image carrier cleaning roller have identical, or approximately identical, diameters.

6. The image forming apparatus according to claim 1, wherein
the second nip width is adjusted depending on an amount by which the transfer medium cleaning roller bites into the transfer medium, and the first nip width is adjusted depending on an amount by which the latent image carrier cleaning roller bites into the latent image carrier.

7. The image forming apparatus according to claim 1, wherein
second nip width is adjusted depending on a pressure at which the transfer medium cleaning roller makes contact with the transfer medium, and the first nip width is adjusted depending on a pressure at which the latent image carrier cleaning roller makes contact with the latent image carrier.

8. The image forming apparatus according to claim 1, wherein
a hardness of the transfer medium cleaning roller is lower than a hardness of the latent image carrier cleaning roller.

9. The image forming apparatus according to claim 1, further comprising:
a transfer medium cleaning blade that abuts against the transfer medium cleaned by the transfer medium cleaning roller.

10. An image forming method comprising:
developing a latent image formed on a latent image carrier, using a liquid developer;
transferring an image developed by the developing section to a transfer medium;
cleaning the latent image carrier by means of a latent image carrier cleaning roller that has a latent image carrier cleaning bias applied thereto, and makes contact with the latent image carrier at a first nip width in a moving direction of the latent image carrier;
transferring the image transferred to the transfer medium to a recording material; and
cleaning the transfer carrier by means of a transfer medium cleaning roller that has a transfer medium cleaning bias applied thereto, and makes contact with the transfer medium at a second nip width that is larger than the first nip width in a moving direction of the transfer medium.
